(19) United States
(12) Patent Application Publication
(10) Pub. No.: US 2024/0101788 A1
(43) Pub. Date: Mar. 28, 2024

(54) SILOXANE COMPOUND, PREPARATION METHOD THEREOF, AND USE THEREOF

(71) Applicant: KOREA KUMHO PETROCHEMICAL CO., LTD., Seoul (KR)

(72) Inventors: Daejune JOE, Daejeon (KR); Min Sung KWON, Daejeon (KR); Dae Hyung LEE, Daejeon (KR); Gihyun SUNG, Daejeon (KR); Hyeong Ho YOON, Daejeon (KR); Gwanghoon Kwag, Daejeon (KR); Jae Yeon An, Daejeon (KR)

(21) Appl. No.: 18/461,521

(22) Filed: Sep. 6, 2023

(30) Foreign Application Priority Data
Sep. 6, 2022 (KR) 10-2022-0112469
Sep. 6, 2022 (KR) 10-2022-0112470

(51) Int. Cl. C08K 5/544; C08F 212/08; C08F 236/06

(52) U.S. Cl. CPC C08K 5/544; C08F 212/08; C08F 236/06; C08F 2810/40

(57) ABSTRACT

One embodiment of the present specification provides a siloxane compound represented by Chemical Formula 1 below:

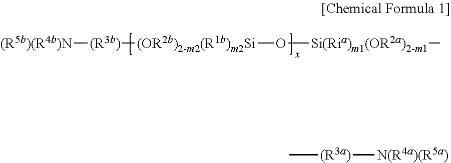

In Chemical Formula 1, R^{1a} and R^{1b} are each independently a substituted or unsubstituted straight or branched-chain alkyl group having 1 to 16 carbon atoms, R^{2a} and R^{2b} are each independently a substituted or unsubstituted straight or branched-chain alkyl group having 1 to 16 carbon atoms, R^{3a} and R^{3b} are each independently a substituted or unsubstituted straight or branched-chain alkylene group having 1 to 16 carbon atoms, R^{4a}, R^{4b}, R^{5a}, and R^{5b} are each independently hydrogen, a substituted or unsubstituted straight or branched alkyl group having 1 to 16 carbon atoms, or a substituted or unsubstituted straight or branched-chain heteroalkyl group having 1 to 16 carbon atoms, m1 and m2 are each an integer from 0 to 2, and when m1 and m2 are each 0, a plurality of OR^{2a} and OR^{2b} are the same or different, and when m1 and m2 are each 2, a plurality of R^{1a} and R^{1b} are the same or different, and x is an integer from 1 to 5.

### CROSS-REFERENCE TO RELATED APPLICATION

This application claims priority to and the benefits of Korean Patent Application No. 2022-0112469, filed on Sep. 6, 2022, and Korean Patent Application No. 2022-0112470, filed on Sep. 6, 2022, the disclosure of which is incorporated herein by reference in its entirety.

### BACKGROUND

### 1. Field of the Invention

The present specification relates to a siloxane compound, a preparation method thereof, and a use thereof.

### 2. Discussion of Related Art

In the automobile industry, demand for improving the properties of automobile tires, such as durability, stability, and fuel saving, is increasing day by day, and due to the recent increase in demand for electric vehicles having high torque values and heavier vehicle weight, there is a particularly increasing demand for improving the wear resistance of rubber for tire treads and enhancing fuel efficiency.

In the case of conjugated diene-based polymers commonly used as rubber materials for tire treads, due to the low dispersion of the inorganic filler in the polymer, there is a problem that processability is significantly reduced when blending rubber for tread, and various types of terminal modifying agents are used to solve this problem.

An aminoalkoxysilane compound is a typical compound used as a terminal modifying agent in the preparation of a functional rubber composition for tire tread, and is used for improving compatibility with a filler by being bonded to an end of the conjugated diene-based polymer. The aminoalkoxysilane compound ultimately serves to improve the wet traction and rolling resistance of the tire, but when the aminoalkoxysilane is reacted with a low molecular weight anionic polymer, there is a problem that the wear resistance of the rubber composition for tire tread is lowered due to its low Mooney viscosity.

Therefore, there is a need for the development of the terminal modifying agent capable of improving both compatibility with a filler and Mooney viscosity during a coupling reaction with an anionic polymer having a low molecular weight, and terminal-modified conjugated diene-based polymers having high Mooney viscosity, excellent wear resistance, and high filler dispersibility, so that they have excellent processability when rubber is blended with inorganic fillers.

### SUMMARY OF THE INVENTION

The description of the present specification is to solve the problems of the related art described above, and one object of the present specification is to provide a novel siloxane compound that can be used as a terminal modifying agent for a conjugated diene-based polymer and a method of preparing the same.

Another object of the present specification is to provide a terminal-modified conjugated diene-based polymer to which a siloxane compound is applied as a terminal modifying agent, and a rubber composition including the same, with excellent processability and wear resistance.

### Means to Solve the Problem

According to one aspect, a siloxane compound represented by Chemical Formula 1 below is provided.

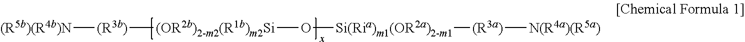

In Chemical Formula 1, R^{1a} and R^{1b} are each independently a substituted or unsubstituted straight or branched-chain alkyl group having 1 to 16 carbon atoms, R^{2a} and R^{2b} are each independently a substituted or unsubstituted straight or branched-chain alkyl group having 1 to 16 carbon atoms, R^{3a} and R^{3b} are each independently a substituted or unsubstituted straight or branched-chain alkylene group having 1 to 16 carbon atoms, R^{4a}, R^{4b}, R^{5a}, and R^{5b} are each independently hydrogen, a substituted or unsubstituted straight or branched alkyl group having 1 to 16 carbon atoms, or a substituted or unsubstituted straight or branched-chain heteroalkyl group having 1 to 16 carbon atoms, m1 and m2 are each an integer from 0 to 2, and when m1 and m2 are each 0, a plurality of OR^{2a} and OR^{2b} are the same or different, and when m1 and m2 are each 2, a plurality of R^{1a} and R^{1b} are the same or different, and x is an integer from 1 to 5.

In one embodiment, at least one of R^{4a}, R^{4b}, R^{5a}, and R^{5b} may be an alkyl group or a heteroalkyl group substituted with a substituent represented by Chemical Formula 2 or Chemical Formula 3 below.

[Chemical Formula 2]

In Chemical Formula 2, R^{6a} is a substituted or unsubstituted straight or branched-chain alkyl group having 1 to 16 carbon atoms, R^{6b} is a substituted or unsubstituted straight or branched-chain alkyl group having 1 to 16 carbon atoms, and m3 is an integer from 0 to 3, and when m3 is 0 or 1, a plurality of OR^{6b} are the same or different, and when m3 is 2 or 3, a plurality of R^{6a} are the same or different.

—N(R^{7a})(R^{7b}) [Chemical Formula 3]

In Chemical Formula 3, R^{7a} and R^{7b} are each independently a substituted or unsubstituted straight or branched-chain alkyl group having 1 to 16 carbon atoms.

In one embodiment, at least one of R^{4a} and R^{4b} may be an alkyl group or a heteroalkyl group substituted with a substituent represented by Chemical Formula 2, and at least one of R^{5a} and R^{5b} may be an alkyl group or a heteroalkyl group substituted with a substituent represented by Chemical Formula 2 or Chemical Formula 3.

According to another aspect, a preparation method of a siloxane compound, which includes: (a) preparing a mixture including chloroalkylalkoxysilane represented by Chemical Formula 4 below, a primary or secondary amine, and a metal halide; (b) reacting the mixture to obtain an aminoalkoxysilane compound; and (c) subjecting the aminoalkoxysilane compound to a dehydration condensation reaction, is provided.

Cl—(R³)—Si(R¹)ₙ(OR²)₃₋ₙ [Chemical Formula 4]

In Chemical Formula 4, R¹ is a substituted or unsubstituted straight or branched-chain alkyl group having 1 to 16 carbon atoms, R² is a substituted or unsubstituted straight or branched-chain alkyl group having 1 to 16 carbon atoms, R³ is a substituted or unsubstituted straight or branched-chain alkylene group having 1 to 16 carbon atoms, and n is an integer of 0 to 2, and when n is 0 or 1, a plurality of OR² are the same or different, and when n is 2, a plurality of R¹ are the same or different.

In one embodiment, the primary or secondary amine may be a compound represented by Chemical Formula 5 below.

NH(R⁴)ₒ[(R⁵)—Si(R⁶)ₚ(OR⁷)₃₋ₚ]₂₋ₒ [Chemical Formula 5]

In Chemical Formula 5, R⁴ is hydrogen, a substituted or unsubstituted straight or branched alkyl group having 1 to 16 carbon atoms, or a substituted or unsubstituted straight or branched-chain heteroalkyl group having 1 to 16 carbon atoms, R⁵ is a substituted or unsubstituted straight or branched-chain alkylene group having 1 to 16 carbon atoms, R⁶ is a substituted or unsubstituted straight or branched-chain alkyl group having 1 to 16 carbon atoms, R⁷ is a substituted or unsubstituted straight or branched-chain alkyl group having 1 to 16 carbon atoms, o is 0 or 1, and when o is 0, a plurality of (R⁵)—Si(R⁶)ₚ(OR⁷)₃₋ₚ are the same or different, and p is an integer from 0 to 2, and when p is 0 or 1, a plurality of OR⁷ are the same or different, and when p is 2, a plurality of R⁶ are the same or different.

In one embodiment, the primary or secondary amine may be a compound represented by Chemical Formula 6 below.

NH(R⁸)_{q}[(R⁹)—N(R¹⁰)(R¹¹)]_{2-q} [Chemical Formula 6]

In Chemical Formula 6, R⁸ is hydrogen, a substituted or unsubstituted straight or branched alkyl group having 1 to 16 carbon atoms, or a substituted or unsubstituted straight or branched-chain heteroalkyl group having 1 to 16 carbon atoms, R⁹ is a substituted or unsubstituted straight or branched-chain alkylene group having 1 to 16 carbon atoms, R¹⁰ and R¹¹ are each independently a substituted or unsubstituted straight or branched-chain alkyl group having 1 to 16 carbon atoms, and q is 0 or 1, and when q is 0, a plurality of (R⁹)—N(R¹⁰)(R¹¹) are the same or different.

In one embodiment, the metal halide may be a compound represented by Chemical Formula 7 below.

MX [Chemical Formula 7]

In Chemical Formula 7, M is an alkali metal and X is a halogen element.

In one embodiment, the metal halide may be a compound represented by Chemical Formula 8 below.

M′X₂ [Chemical Formula 8]

In Chemical Formula 8, M′ is an alkaline earth metal and X is a halogen element.

In one embodiment, a content of the chloroalkylalkoxysilane included in the mixture may be 1.1 to 10 moles per mole of the primary or secondary amine.

In one embodiment, an amount of the metal halide included in the mixture may be 0.01 to 5 moles per mole of the primary or secondary amine.

In one embodiment, the mixture may further include a base.

In one embodiment, the base may be one selected from the group consisting of triethylamine (TEA), N,N-diisopropylethylamine (DIEA), N,N-Ethylisopropylamine (Hunig base), 1,1,3,3-tetramethylguanidine (TMG), and a combination of two or more thereof.

In one embodiment, the reaction of step (b) may be performed at 60 to 200° C.

In one embodiment, the reaction of step (b) may be performed for 1 to 100 hours.

In one embodiment, the reaction of step (b) may be performed under a pressure of 0.1 to bar.

According to still another aspect, a terminal-modified conjugated diene-based polymer in which the siloxane compound is bonded to an end of a conjugated diene-based polymer is provided.

In one embodiment, the conjugated diene-based polymer may be a homopolymer of conjugated diene-based monomers or a copolymer of a conjugated diene-based monomer and an aromatic vinyl-based monomer.

According to yet another aspect, a rubber composition including the terminal-modified conjugated diene-based polymer is provided.

### DETAILED DESCRIPTION OF EXEMPLARY EMBODIMENTS

Hereinafter, one aspect of the present specification will be described with reference to the accompanying drawings. However, the description of the present specification may be implemented in several different forms, and thus is not limited to the embodiments described herein. In order to clearly illustrate the present invention in the drawings, parts irrelevant to the description are omitted, and the same reference numerals are added to the same or similar parts throughout the specification.

Throughout the specification, when a part is “connected” to another part, this includes not only the case where it is “directly connected” but also the case where it is “indirectly connected” with another member interposed therebetween. In addition, when a part is said to “include” a component, this means that other components may be further included, not excluded, unless specifically stated otherwise.

When a range of numerical values is recited herein, the values have the precision of the significant figures provided in accordance with the standard rules in chemistry for significant figures, unless the specific range is otherwise stated. For example, 10 includes the range of 5.0 to 14.9, and the number 10.0 includes the range of 9.50 to 10.49.

As used herein, the term “substitution” means that one or more hydrogen atoms bonded to a carbon atom of a compound are each independently replaced with another substituent. The substituents may include, but are not limited to, an alkyl group, a heteroalkyl group, a silyl group, an alkoxy group, an amino group, a cyano group, a nitro group, a halogen group, a hydroxyl group, an aryl group, a heteroaryl group, and a substituent in which two or more of the substituents exemplified above are linked. The substituent in which two or more substituents are linked means that hydrogen of any one substituent is replaced with another substituent, and for example, include not only those in which three substituents linked are (substituent 1)-(substituent 2)-(substituent 3) connected in succession, but also those in which (substituent 2) and (substituent 3) are linked to (substituent 1).

As used herein, the term “alkyl group” means a hydrocarbon group “CₙH₂ₙ₊₁—.” For example, the alkyl group includes, but is not limited to, a methyl group (Me), an ethyl group, a propyl group, a n-propyl group, an isopropyl group, a butyl group, a n-butyl group, an isobutyl group, a tert-butyl group, a pentyl group, an n-pentyl group, a hexyl group, an n-hexyl group, a heptyl group, an n-heptyl group, an octyl group, and an n-octyl group, and the like.

As used herein, the term “heteroalkyl group” means an alkyl group in which one or more carbon atoms are substituted with hetero atoms.

As used herein, the term “heteroatom” means all atoms other than carbon and hydrogen, and for example, includes, but is not limited to, oxygen, nitrogen, sulfur, phosphorus, and halogen atoms.

As used herein, the term “alkylene group” means a hydrocarbon group “—CₙH₂ₙ—” having two valences. For example, the alkylene group includes, but is not limited to, a methylene group (—CH₂—), an ethylene group (—CH₂—CH₂—), a propylene group (—CH₂CH₂CH₂—), and the like.

Hereinafter, embodiments of the present application will be described in detail.

### Siloxane Compound

A siloxane compound according to an aspect of the present specification is represented by Chemical Formula 1 below.

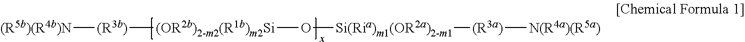

In Chemical Formula 1, R^{1a} and R^{1b} are each independently a substituted or unsubstituted straight or branched-chain alkyl group having 1 to 16 carbon atoms, R^{2a} and R^{2b} are each independently a substituted or unsubstituted straight or branched-chain alkyl group having 1 to 16 carbon atoms, R^{3a} and R^{3b} are each independently a substituted or unsubstituted straight or branched-chain alkylene group having 1 to 16 carbon atoms, R^{4a}, R^{4b}, R^{5a}, and R^{5b} are each independently hydrogen, a substituted or unsubstituted straight or branched alkyl group having 1 to 16 carbon atoms, or a substituted or unsubstituted straight or branched-chain heteroalkyl group having 1 to 16 carbon atoms, m1 and m2 are each an integer from 0 to 2, and when m1 and m2 are each 0, a plurality of OR^{2a} and OR^{2b} are the same or different, and when m1 and m2 are each 2, a plurality of R^{1a} and R^{1b} are the same or different, and x is an integer from 1 to 5. For example, in Chemical Formula 1, R^{1a} and R^{1b} are each independently a substituted or unsubstituted alkyl group having 1 to 2 carbon atoms, R^{2a} and R^{2b} are each independently a substituted or unsubstituted straight or branched-chain alkyl group having 1 to 4 carbon atoms, R^{1a} and R^{3b} are each independently a substituted or unsubstituted straight or branched-chain alkylene group having 1 to 4 carbon atoms, R^{4a}, R^{4b}, R^{5a} and R^{5b} are each independently hydrogen, a substituted or unsubstituted straight or branched alkyl group having 1 to 16 carbon atoms, or a substituted or unsubstituted straight or branched-chain heteroalkyl group having 1 to 12 carbon atoms, but is not limited thereto.

At least one of R^{4a}, R^{4b}, R^{5a}, and R^{5b} may be an alkyl group or a heteroalkyl group substituted with a substituent represented by Chemical Formula 2 or Chemical Formula 3 below.

—Si(R^{6a})ₘ₃(OR^{6b})₃₋ₘ₃ [Chemical Formula 2]

In Chemical Formula 2, R^{6a} is a substituted or unsubstituted straight or branched-chain alkyl group having 1 to 16 carbon atoms, R^{6b} is a substituted or unsubstituted straight or branched-chain alkyl group having 1 to 16 carbon atoms, and m3 is an integer from 0 to 3, and when m3 is 0 or 1, a plurality of OR^{6b} are the same or different, and when m3 is 2 or 3, a plurality of R^{6a} are the same or different. For example, in Chemical Formula 2, R^{6a} may be a substituted or unsubstituted alkyl group having 1 to 2 carbon atoms, and R^{6b} may be a substituted or unsubstituted straight or branched-chain alkyl group having 1 to 4 carbon atoms, but is not limited thereto.

—N(R^{7a})(R^{7b}) [Chemical Formula 3]

In Chemical Formula 3, R^{7a} and R^{7b} are each independently a substituted or unsubstituted straight or branched-chain alkyl group having 1 to 16 carbon atoms. For example, in Chemical Formula 3, R^{7a} and R^{7b} may each independently be a substituted or unsubstituted straight or branched-chain alkyl group having 1 to 4 carbon atoms, but is not limited thereto.

At least one of R^{4a} and R^{4b} may be an alkyl group or a heteroalkyl group substituted with a substituent represented by Chemical Formula 2, and at least one of R^{5a} and R^{5b} may be an alkyl group or a heteroalkyl group substituted with a substituent represented by Chemical Formula 2 or Chemical Formula 3. For example, R^{4a} and R^{4b} may be an alkyl group substituted with a substituent represented by Chemical Formula 2, and R^{5a} and R^{5b} may be an alkyl group substituted with a substituent represented by Chemical Formula 2 or Chemical Formula 3, but are not limited thereto.

The siloxane compound may be used as a terminal modifying agent for a conjugated diene-based polymer, a surface treatment agent, a resin additive, a coating additive, or an adhesive, but is not limited thereto.

### Method of Preparing Siloxane Compound

A method of preparing a siloxane compound according to another aspect of the present specification includes: (a) preparing a mixture including chloroalkylalkoxysilane represented by Chemical Formula 4 below, a primary or secondary amine, and a metal halide; (b) reacting the mixture to obtain an aminoalkoxysilane compound; and (c) subjecting the aminoalkoxysilane compound to a dehydration condensation reaction.

Cl—(R³)—Si(R¹)ₙ(OR²)₃₋ₙ [Chemical Formula 4]

In Chemical Formula 4, R¹ is a substituted or unsubstituted straight or branched-chain alkyl group having 1 to 16 carbon atoms, R² is a substituted or unsubstituted straight or branched-chain alkyl group having 1 to 16 carbon atoms, R³ is a substituted or unsubstituted straight or branched-chain alkylene group having 1 to 16 carbon atoms, and n is an integer of 0 to 2, and when n is 0 or 1, a plurality of OR² are the same or different, and when n is 2, a plurality of R¹ are the same or different. For example, in Chemical Formula 4, R¹ is a substituted or unsubstituted alkyl group having 1 to 2 carbon atoms, R² is a substituted or unsubstituted straight or branched-chain alkyl group having 1 to 4 carbon atoms, and R³ is a substituted or unsubstituted straight or branched-chain alkylene group having 1 to 4 carbon atoms, but are not limited thereto.

The chloroalkylalkoxysilane may be (3 -chloropropyl)trimethoxysilane (Cl(CH₂)₃Si(OCH₃)₃), but is not limited thereto.

The primary or secondary amine may be a compound represented by Chemical Formula 5 below.

NH(R⁴)ₒ[(R⁵)—Si(R⁶)ₚ(OR⁷)₃₋ₚ]₂₋ₒ [Chemical Formula 5]

In Chemical Formula 5, R⁴ is hydrogen, a substituted or unsubstituted straight or branched alkyl group having 1 to 16 carbon atoms, or a substituted or unsubstituted straight or branched-chain heteroalkyl group having 1 to 16 carbon atoms, R⁵ is a substituted or unsubstituted straight or branched-chain alkylene group having 1 to 16 carbon atoms, R⁶ is a substituted or unsubstituted straight or branched-chain alkyl group having 1 to 16 carbon atoms, R⁷ is a substituted or unsubstituted straight or branched-chain alkyl group having 1 to 16 carbon atoms, and o is 0 or 1, and when o is 0, a plurality of (R⁵)—Si(R⁶)ₚ(OR⁷)₃₋ₚ are the same or different, and p is an integer from 0 to 2, and when p is 0 or 1, a plurality of OR⁷ are the same or different, and when p is 2, a plurality of R⁶ are the same or different. For example, in Chemical Formula 5, R⁴ is hydrogen, a substituted or unsubstituted straight or branched alkyl group having 1 to 16 carbon atoms, or a substituted or unsubstituted straight or branched-chain heteroalkyl group having 1 to 12 carbon atoms, R⁵ is a substituted or unsubstituted straight or branched-chain alkylene group having 1 to 4 carbon atoms, R⁶ is a substituted or unsubstituted alkyl group having 1 to 2 carbon atoms, and R⁷ is a substituted or unsubstituted straight-chain or branched-chain alkyl group having 1 to 4 carbon atoms, but are not limited thereto.

The primary or secondary amine may be a compound represented by Chemical Formula 6 below.

NH(R⁸)_{q}[(R⁹)—N(R¹⁰)(R¹¹)]_{2-q} [Chemical Formula 6]

In Chemical Formula 6, R⁸ is hydrogen, a substituted or unsubstituted straight or branched alkyl group having 1 to 16 carbon atoms, or a substituted or unsubstituted straight or branched-chain heteroalkyl group having 1 to 16 carbon atoms, R⁹ is a substituted or unsubstituted straight or branched-chain alkylene group having 1 to 16 carbon atoms, R¹⁰ and R¹¹ are each independently a substituted or unsubstituted straight or branched-chain alkyl group having 1 to 16 carbon atoms, and q is 0 or 1, and when q is 0, a plurality of (R⁹)—N(R¹⁰R¹¹) are the same or different. For example, in Chemical Formula 6, R⁸ is hydrogen, a substituted or unsubstituted straight or branched alkyl group having 1 to 16 carbon atoms, or a substituted or unsubstituted straight or branched-chain heteroalkyl group having 1 to 12 carbon atoms, R⁹ is a substituted or unsubstituted straight or branched-chain alkylene group having 1 to 4 carbon atoms, and R¹⁰ and R¹¹ is a substituted or unsubstituted straight-chain or branched-chain alkyl group having 1 to 4 carbon atoms, but are not limited thereto.

The primary or secondary amine may be 3-(trimethoxysilyl)propylamine (H₂N(CH₂)₃Si(OCH₃)₃) or (3-(diethylamino)propylamine (H₂N(CH₂)₃N(C₂H₅)₂), but is not limited thereto.

In step (a), by using a metal halide as an additive together with chloroalkylalkoxysilane and a primary or secondary amine, the reaction time of step (b) can be reduced by 50% or more compared to the case where no metal halide is used, and the selectivity and yield of the aminoalkoxysilane compound as a product can be improved.

The metal halide may be a compound represented by Chemical Formula 7 below.

MX [Chemical Formula 7]

In Chemical Formula 7, M is an alkali metal and X is a halogen element.

The alkali metal may be Li, Na, K, Rb, Cs, or Fr, and the halogen element may be F, Cl, Br, or I. For example, the metal halide may be NaBr, NaI, or KBr, but is not limited thereto.

The metal halide may be a compound represented by Chemical Formula 8 below.

M′X₂ [Chemical Formula 8]

In Chemical Formula 8, M′ is an alkaline earth metal and X is a halogen element.

The alkaline earth metal may be Be, Mg, Ca, Sr, Ba, or Ra, and the halogen element may be F, Cl, Br, or I.

A content of the chloroalkylalkoxysilane included in the mixture may be 1.1 to 10 moles, for example, 1.1 moles, 1.2 moles, 1.3 moles, 1.4 moles, 1.5 moles, 1.6 moles, 1.7 moles, 1.8 moles, 1.9 moles, 2.0 moles, 2.1 moles, 2.2 moles, 2.3 moles, 2.4 moles, 2.5 moles, 2.6 moles, 2.7 moles, 2.8 moles, 2.9 moles, 3.0 moles, 3.1 moles, 3.2 moles, 3.3 moles, 3.4 moles, 3.5 moles, 3.6 moles, 3.7 moles, 3.8 moles, 3.9 moles, 4.0 moles, 4.1 moles, 4.2 moles, 4.3 moles, 4.4 moles, 4.5 moles, 4.6 moles, 4.7 moles, 4.8 moles, 4.9 moles, 5.0 moles, 5.1 moles, 5.2 moles, 5.3 moles, 5.4 moles, 5.5 moles, 5.6 moles, 5.7 moles, 5.8 moles, 5.9 moles, 6.0 moles, 6.1 moles, 6.2 moles, 6.3 moles, 6.4 moles, 6.5 moles, 6.6 moles, 6.7 moles, 6.8 moles, 6.9 moles, 7.0 moles, 7.1 moles, 7.2 moles, 7.3 moles, 7.4 moles, 7.5 moles, 7.6 moles, 7.7 moles, 7.8 moles, 7.9 moles, 8.0 moles, 8.1 moles, 8.2 moles, 8.3 moles, 8.4 moles, 8.5 moles, 8.6 moles, 8.7 moles, 8.8 moles, 8.9 moles, 9.0 moles, 9.1 moles, 9.2 moles, 9.3 moles, 9.4 moles, 9.5 moles, 9.6 moles, 9.7 moles, 9.8 moles, 9.9 moles, 10.0 moles, or any value between these two values per mole of the primary or secondary amine. In one example, the content may be 1.3 to 4 moles per mole of the primary or secondary amine, but is not limited thereto. When the content of the chloroalkylalkoxysilane is outside the above range, the yield of the aminoalkoxysilane compound in step (b) may decrease.

A content of the metal halide included in the mixture may be 0.01 to 5 moles, for example, 0.01 moles, 0.1 moles, 0.2 moles, 0.3 moles, 0.4 moles, 0.5 moles, 0.6 moles, 0.7 moles, 0.8 moles, 0.9 moles, 1.0 mole, 1.1 moles, 1.2 moles, 1.3 moles, 1.4 moles, 1.5 moles, 1.6 moles, 1.7 moles, 1.8 moles, 1.9 moles, 2.0 moles, 2.1 moles, 2.2 moles, 2.3 moles, 2.4 moles, 2.5 moles, 2.6 moles, 2.7 moles, 2.8 moles, 2.9 moles, 3.0 moles, 3.1 moles, 3.2 moles, 3.3 moles, 3.4 moles, 3.5 moles, 3.6 moles, 3.7 moles, 3.8 moles, 3.9 moles, 4.0 moles, 4.1 moles, 4.2 moles, 4.3 moles, 4.4 moles, 4.5 moles, 4.6 moles, 4.7 moles, 4.8 moles, 4.9 moles, 5.0 moles, or any value between these two values per mole of the primary or secondary amine. In one example, the content may be 1 to 4 moles per mole of the primary or secondary amine, but is not limited thereto. When the content of the metal halide is less than the above range, the reaction time of the step (b) may be prolonged, which may decrease process efficiency, and when the content exceeds the above range, process economics may be reduced.

The mixture may further include a base. That is, step (a) may be a step of preparing a mixture including chloroalkylalkoxysilane, a primary or secondary amine, a metal halide, and a base.

The base may be one selected from the group consisting of triethylamine (TEA), N,N-diisopropylethylamine (DIEA), N,N-Ethylisopropylamine (Hunig base), 1,1,3,3-tetramethylguanidine (TMG), and a combination of two or more thereof, but is not limited thereto.

A content of the base may be 1 to 4 moles per mole of the primary or secondary amine, but is not limited thereto.

Step (b) is a step of reacting the mixture prepared in step (a), and may be performed while stirring.

The reaction of step (b) may be performed at 60 to 200° C. For example, the temperature may be 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., 200° C., or a value between two of these values. When the reaction temperature is less than the above range, the reaction time may increase or the yield of the aminoalkoxysilane compound may decrease, and when the reaction temperature exceeds the above range, the yield of the aminoalkoxysilane compound and process safety may decrease.

The reaction of step (b) may be performed for 1 to 100 hours. For example, the reaction may be performed for 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 24 hours, 25 hours, 26 hours, 27 hours, 28 hours, 29 hours, 30 hours, 31 hours, 32 hours, 33 hours, 34 hours, 35 hours, 36 hours, 37 hours, 38 hours, 39 hours, 40 hours, 41 hours, 42 hours, 43 hours, 44 hours, 45 hours, 46 hours, 47 hours, 48 hours, 49 hours, 50 hours, 51 hours, 52 hours, 53 hours, 54 hours, 55 hours, 56 hours, 57 hours, 58 hours, 59 hours, 60 hours, 61 hours, 62 hours, 63 hours, 64 hours, 65 hours, 66 hours, 67 hours, 68 hours, 69 hours, 70 hours, 71 hours, 72 hours, 73 hours, 74 hours, 75 hours, 76 hours, 77 hours, 78 hours, 79 hours, 80 hours, 81 hours, 82 hours, 83 hours, 84 hours, 85 hours, 86 hours, 87 hours, 88 hours, 89 hours, 90 hours, 91 hours, 92 hours, 93 hours, 94 hours, 95 hours, 96 hours, 97 hours, 98 hours, 99 hours, 100 hours, or any time between these two values.

The reaction of step (b) may be performed under a pressure of 0.1 to 10 bar. For example, the reaction may be performed under a pressure 0.1 bar, 0.2 bar, 0.3 bar, 0.4 bar, 0.5 bar, 0.6 bar, 0.7 bar, 0.8 bar, 0.9 bar, 1 bar, 2 bar, 3 bar, 4 bar, 5 bar, 6 bar, 7 bar, 8 bar, 9 bar, 10 bar, or any pressure between two of these values.

In step (b), the yield of the aminoalkoxysilane compound may be 80% or more. For example, the yield may be 80%, 81%, 82%, 83%, 84%, 85%, 86%, 87%, 88%, 89%, 90%, 91%, 92%, 93%, 94%, 95%, 96%, 97%, 98%, 99%, 99.5%, 99.9%, or a value between two of these values.

Step (c) is a step of synthesizing a siloxane compound by subjecting the aminoalkoxysilane compound to a dehydration condensation reaction, and may include reacting the aminoalkoxysilane compound with water, wherein the dehydration condensation reaction may be performed by stirring for 6 to 10 hours at a temperature of 70 to 90° C., but is not limited thereto.

Step (c) may further include filtering the reaction product after the dehydration condensation reaction. Through filtration of the reaction product, it is possible to remove solid condensates of trimers or higher-order oligomers.

Step (c) may further include distilling the reaction product after the dehydration condensation reaction. Unreacted monomers can be removed by distillation of the reaction product.

The siloxane compound prepared by the above method may have a dimer structure in which two molecules of an aminoalkoxysilane compound are condensed. The siloxane compound having the dimer structure has twice as many alkoxysilane groups that can react with an anionic polymer compared to a monomer structure, so that a terminal-modified conjugated diene-based polymer having high Mooney viscosity can be prepared even during a coupling reaction with a low molecular weight anionic polymer.

### Terminal-Modified Conjugated Diene-Based Polymer

The terminal-modified conjugated diene-based polymer according to another aspect of the present specification may be one in which the above-described siloxane compound is bonded to an end of a conjugated diene-based polymer.

The terminal-modified conjugated diene-based polymer may be one in which the above-described siloxane compound is bonded to one or both ends of a conjugated diene-based polymer. Modification by binding a siloxane compound to the end of the conjugated diene-based polymer improves filler dispersibility, thereby improving processability during rubber blending, and as the Mooney viscosity increases, mechanical properties including wear resistance of the final product may be improved.

The conjugated diene-based polymer may be a homopolymer of conjugated diene-based monomers or a copolymer of a conjugated diene-based monomer and an aromatic vinyl-based monomer.

The conjugated diene-based monomer may be one selected from the group consisting of 1,3-butadiene, isoprene, 2,3-dimethyl-1,3-butadiene, 1,3-pentadiene, 1,3-hexadiene, 2-phenyl-1,3-butadiene, 3-methyl-1,3-pentadiene, 2-chloro-1,3-butadiene, 3-butyl-1,3-octadiene, octadiene, and a combination of two or more thereof, but is not limited thereto.

The aromatic vinyl-based monomer may be one selected from the group consisting of styrene, α-methylstyrene, 2-methylstyrene, 3-methylstyrene, 4-methylstyrene, 2,4-dimethylstyrene, 2,4-diisopropylstyrene, 4-propylstyrene, 4-cyclohexylstyrene, 4-(p-methylphenyl)styrene, 5-tert-butyl-2-methylstyrene, tert-butoxystyrene, 2-tert-butylstyrene, 3-tert-butylstyrene, 4-tert-butylstyrene, N,N-dimethylaminoethylstyrene, 1-vinyl-5-hexylnaphthalene, 1-vinylnaphthalene, divinylnaphthalene, divinylbenzene, trivinylbenzene, vinylbenzyldimethylamine, (4-vinylbenzyl)dimethylaminoethyl ether, vinylpyridine, vinylxylene, diphenylethylene, diphenylethylene including a tertiary amine, styrene including a primary, secondary, or tertiary amine, and a combination of two or more thereof, but is not limited thereto.

The terminal-modified conjugated diene-based polymer may be prepared by a solution polymerization method, but is not limited thereto.

The weight average molecular weight (Mw) of the conjugated diene-based polymer may be 1,000 to 200,000 g/mol. When a weight average molecular weight of the conjugated diene-based polymer is less than the above range, Mooney viscosity may be lowered and wear resistance of the final product may be lowered, and when the molecular weight exceeds the above range, dispersibility of a filler may decrease and processability at the time of rubber blending may deteriorate.

### Rubber Composition

A rubber composition according to still another aspect of the present specification includes the above-described terminal-modified conjugated diene-based polymer.

The rubber composition may further include a filler. The filler may be carbon black or silica, but is not limited thereto.

The rubber composition may be applied to manufacture of rubber for tire treads, but is not limited thereto. A tire made of the rubber composition has excellent mechanical properties such as wear resistance and excellent safety and fuel efficiency, so that it can be applied to an electric vehicle with a heavy body.

Hereinafter, examples of the present specification will be described in more detail. However, the following experimental results describe only representative experimental results among the examples, and the scope and content of the present invention cannot be construed as reduced or limited by the examples. Each effect of the various embodiments of the present invention not explicitly presented below will be specifically described in the corresponding section.

### Preparation Examples 1 to 9

(3-Chloropropyl)trimethoxysilane (Cl(CH₂)₃Si(OCH₃)₃), 3-(trimethoxysilyl)propylamine (H₂N(CH₂)₃Si(OCH₃)₃), a base and a metal halide were mixed according to Table 1 below. The mixture was reacted by stirring under a temperature of 133° C. and a pressure of 2.1 bar, and then cooled to room temperature. Mixed Heptane (C₇H₁₆) was added to precipitate the formed salt, a suspension was filtered, and the solvent was evaporated. A product was distilled under reduced pressure to obtain N,N,N-tris(trimethoxysilylpropyl)amine as a colorless liquid.

### Comparative Preparation Example

A mixture of 196 mmol of (3-chloropropyl)trimethoxysilane, 55.6 mmol of 3-(trimethoxysilyl)propylamine, and 224 mmol of N,N-diisopropylethylamine (DIEA) was heated to 133° C. while stirring until starting materials were completely consumed. After confirming that the starting materials was completely consumed, the mixture was cooled to room temperature. 300 mL of pentane was added to precipitate the formed salt, a suspension was filtered, and the solvent was evaporated. A crude product was distilled under reduced pressure to obtain N,N,N-tris(trimethoxysilylpropyl)amine as a yellow viscous liquid.

TABLE 1

| | | Primary or | | | | |
|---|---|---|---|---|---|---|
| | Chloroalkyl | secondary | | | | Metal |
| | alkoxysilane | amine | | Base | | halide |
| | content | content | | content | Metal | content |
| Classification | (mmol) | (mmol) | Base | (mmol) | halide | (mmol) |
| Preparation | 162.6 | 50.8 | TEA | 106.7 | NaBr | 106.7 |
| Example 1 | | | | | | |
| Preparation | 163.8 | 51.2 | TEA | 107.5 | NaI | 105.0 |
| Example 2 | | | | | | |
| Preparation | 164.5 | 51.4 | TEA | 107.9 | KBr | 106.9 |
| Example 3 | | | | | | |
| Preparation | 170.2 | 53.2 | DIEA | 111.7 | NaBr | 112.8 |
| Example 4 | | | | | | |
| Preparation | 178.6 | 55.8 | DIEA | 117.2 | NaI | 113.3 |
| Example 5 | | | | | | |
| Preparation | 159.7 | 49.9 | DIEA | 104.8 | KBr | 102.8 |
| Example 6 | | | | | | |
| Preparation | 173.4 | 54.2 | TMG | 113.8 | NaBr | 112.7 |
| Example 7 | | | | | | |
| Preparation | 169.9 | 53.1 | TMG | 111.5 | NaI | 112.6 |
| Example 8 | | | | | | |
| Preparation | 171.2 | 53.5 | TMG | 112.4 | KBr | 114.5 |
| Example 9 | | | | | | |
| Comparative | 196 | 55.6 | DIEA | 224 | — | — |
| Preparation | | | | | | |
| Example | | | | | | |

TEA: Triethylamine ((C₂H₅)₃N)
DIEA: N,N-Diisopropylethylamine ([(CH₃)₂CH]₂NC₂H₅)
TMG: 1,1,3,3-Tetramethylguanidine ((CH₃)₂NC(═NH)N(CH₃)₂)

### Experimental Example 1

In the preparation methods of Preparation Examples 1 to 9 and Comparative Preparation Example, the reaction time and product yield were measured and shown in Table 2 below.

TABLE 2

| Classification | Reaction time (hr) | Yield (%) |
|---|---|---|
| Preparation Example 1 | 48 | 96 |
| Preparation Example 2 | 24 | 85 |
| Preparation Example 3 | 36 | 93 |
| Preparation Example 4 | 43 | 96 |
| Preparation Example 5 | 24 | 87 |
| Preparation Example 6 | 36 | 92 |
| Preparation Example 7 | 40 | 97 |
| Preparation Example 8 | 20 | 86 |
| Preparation Example 9 | 36 | 92 |
| Comparative Preparation | 96 | 90 |
| Example | | |

Referring to Table 2, the preparation methods of Preparation Examples 1 to 9 showed a high yield of 91.56% on average, and in particular, Preparation Examples 1, 4 and 7 using NaBr as an additive showed a yield of 96% or more.

In addition, the preparation methods of Preparation Examples 1 to 9 have a reaction time of 20 to 48 hours, and the reaction was completed within one or two days, but in the case of Comparative Preparation Example in which no metal halide was added, it was confirmed that a reaction time of 96 hours, that is, 4 days, was required. In particular, in the case of Preparation Examples 2, 5, and 8 using NaI as an additive, the reaction was completed within 24 hours, requiring a short reaction time of less than 25% of the reaction time of Comparative Preparation Example.

### Preparation Example 10

A mixture of 162.6 mmol of (3-chloropropyl)trimethoxysilane, 50.8 mmol of 3-(diethylamino)propylamine (H₂N(CH₂)₃N(C₂H₅)₂), 106.7 mmol of TEA, and 106.7 mmol of NaBr was reacted by stirring under a temperature of 133° C. and a pressure of 2.1 bar, and then cooled to room temperature. Heptane (C₇H₁₆) was added to precipitate the formed salt, a suspension was filtered, and the solvent was evaporated. A product was distilled under reduced pressure to obtain N′-diethylaminopropyl-N,N-bis(trimethoxysilylpropyl)amine as a colorless liquid.

### Preparation Example 11

Each of aminoalkoxysilane compounds prepared in Preparation Examples 1 and 10 was stirred with distilled water having a pH of 6 to 8 under a temperature of 80° C. and a pressure of 1 bar, and subjected to a dehydration condensation reaction for 8 hours. The reaction product was filtered to remove solid condensates of trimers or higher-order oligomers, and unreacted monomers were removed through distillation to obtain siloxane compounds having a dimer structure represented by Chemical Formula 9 or Chemical Formula 10 below.

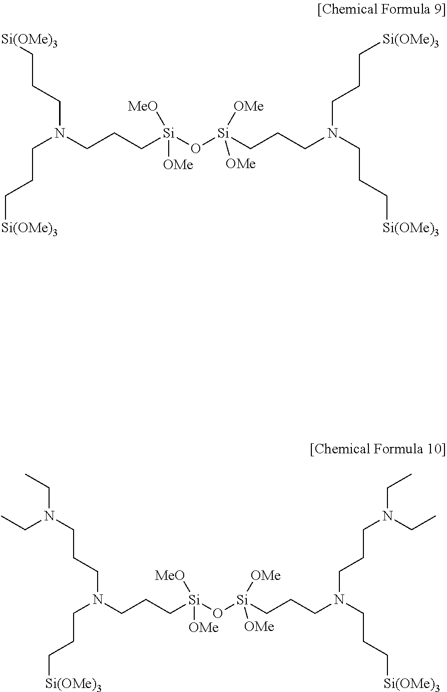

### EXAMPLE 1

140 g of styrene, 180 g of 1,3-butadiene, 2,200 g of cyclohexane, and 10 ml of tetrahydrofuran were input into a 5 L reactor, and then an internal temperature of the reactor was adjusted to 35° C. while stirring. When the internal temperature of the reactor reached 35° C., 2.4 mmol of n-butyllithium as a polymerization initiator was input to carry out an adiabatic temperature-raising polymerization reaction. At this time, progress of the polymerization reaction was observed through a change in reaction temperature, and a polymerization conversion rate of the monomer was analyzed by sampling a small amount of reactants during the reaction.

When the polymerization conversion rate reached 99%, 9 g of 1,3-butadiene was additionally input to replace the reaction terminal with 1,3 -butadiene. Thereafter, 5 mmol of the compound represented by Chemical Formula 9 prepared in Preparation Example 11 was added as a terminal modifying agent to perform a terminal modification reaction.

When terminal modification was completed, 4 g of butylated hydroxy toluene (BHT) as an antioxidant was input to terminate the reaction, followed by stripping and roll drying to obtain a polymer from which residual solvent and water were removed.

### EXAMPLE 2

A polymer was obtained in the same manner as in Example 1, except that 5 mmol of the compound represented by Chemical Formula 10 prepared in Preparation Example 11 was added as a terminal modifying agent.

### Comparative Example 1

A polymer was obtained in the same manner as in Example 1, except that 3.5 mmol of N,N,N-tris(trimethoxysilylpropyl)amine prepared in Preparation Example 1 was added as a terminal modifying agent.

### Comparative Example 2

A polymer was obtained in the same manner as in Example 1, except that 3.5 mmol of N′-diethylaminopropyl-N,N-bis(trimethoxysilylpropyl)amine prepared in Preparation Example 10 was added as a terminal modifying agent.

### Experimental Example 2: Characteristics of Terminal-Modified Copolymer

The properties of each of the terminal-modified copolymers prepared in Examples 1 and 2 and Comparative Examples 1 and 2 are shown in Table 3 below. In Table 3 below, a terminal modification rate, a styrene content, and a vinyl content are mol % values calculated using NMR analysis results, and a weight average molecular weight was measured through gel permeation chromatography (GPC).

TABLE 3

| | | Weight | | | |
|---|---|---|---|---|---|
| | Terminal | average | Mooney | | |
| | modification | molecular | Viscosity | Styrene | Vinyl content |
| | rate | weight | (ML₁₊₄@100° | content | in BD units |
| Classification | (mol %) | (kg/mol) | C.) | (mol %) | (mol %) |
| Example 1 | 89 | 695 | 86 | 10.2 | 39.7 |
| Example 2 | 74 | 624 | 79 | 10.0 | 39.4 |
| Comparative | 65 | 564 | 75 | 9.9 | 39.5 |
| Example 1 | | | | | |
| Comparative | 56 | 552 | 73 | 10.1 | 39.7 |
| Example 2 | | | | | |

### Experimental Example 3: Evaluation of Physical Properties of Rubber Composition for Tire Tread

Each of copolymers prepared according to Examples 1 and 2 and Comparative Examples 1 and 2 was blended with silica in a 500 cc lab mixer according to the conditions shown in Table 4 to prepare a rubber composition for tire tread.

TABLE 4

| Blending composition | Content (phr) |
|---|---|
| Solution SBR | 80 (each of copolymers prepared |
| | according to Examples 1 and 2 and |
| | Comparative Examples 1 and 2) |
| High Cis-BR | 20 (Nd-BR 40, Kumho |
| | Petrochemical Co., Ltd.) |
| Stearic acid | 2 |
| Zinc oxide | 3 |
| Silica | 80 |
| Process oil | 10 |
| Si-69 | 6.4 |
| CZ | 1 |
| DPG | 1.5 |
| Sulfur | 1.5 |

Processability of the blended rubber and physical properties after blending were measured and compared, and the results are shown in Table 5 below. Each physical property measurement method is as follows.
Hardness: measured using a SHORE-A hardness tester.
Tensile strength, 300% modulus and elongation: measured according to ASTM 3189 Method B using a universal test machine (UTM).
Dynamic property value of vulcanized rubber (Tan δ): analyzed at a frequency of 10 Hz under a strain condition of 0.2 using Rheometic's DTMA 5 instrument.
Mooney viscosity of blend: The unvulcanized blend was attached to the front and back of a rotor and mounted on a rotational viscometer (ALPHA Technologies, MOONEY MV2000). After preheating to 100° C. for the first 1 minute, the rotor was started and a viscosity change of the blend was measured for 4 minutes to measure the Mooney viscosity of the blend expressed as ML₁₊₄@100° C.

TABLE 5

| Physical | | | | Comparative | Comparative |
|---|---|---|---|---|---|
| properties | Classification | Example 1 | Example 2 | Example 1 | Example 2 |
| Mechanical | Hardness (Shore-A) | 71 | 71 | 71 | 71 |
| properties | Tensile strength | 180 | 172 | 165 | 163 |
| | (kgf/cm²): | | | | |
| | 300% Modulus | 169 | 167 | 156 | 148 |
| | (kgf/cm²) | | | | |
| | Elongation (%) | 384 | 372 | 360 | 358 |
| Dynamic | Glass transition | −48.0 | −48.6 | −48.1 | −48.4 |
| properties | temperature | | | | |
| | of blend (° C.) | | | | |
| | Wet traction | 0.2263 | 0.2195 | 0.2205 | 0.2143 |
| | (Tanδ at 0° C.) | | | | |
| | Rolling Resistance | 0.0695 | 0.0781 | 0.0713 | 0.0812 |
| | (Tanδ at 60° C.) | | | | |
| Processability/ | Mooney viscosity of blend | 78 | 82 | 79 | 84 |
| storage | (ML₁₊₄@100° C.) | | | | |
| stability | Low-temperature | 0.65 | 0.79 | 0.78 | 0.98 |
| | flowability | | | | |
| | (mg/min) | | | | |

Referring to Table 5, it can be seen that the rubber compositions containing the copolymers of Examples 1 and 2 have lower Mooney viscosity and low-temperature flowability than those of the rubber compositions containing the copolymers of Comparative Examples 1 and 2, respectively, resulting in improved processability and storage stability. In particular, since the rubber compositions of Examples 1 and 2 have low low-temperature flowability and may maintain their original packaging shape regardless of weight, pressure, and time when packaging a certain size, it may be advantageous to consumers who prepare and manufacture other products using them. Such low low-temperature flowability seems to occur when the side branch structure of the polymer increases.

In addition, it was confirmed that the hardness, tensile strength, 300% modulus, and elongation of the rubber compositions blended with the copolymers of Examples 1 and 2 were partially improved compared to those of the rubber compositions blended with the copolymers of Comparative Examples 1 and 2, and comparing tans values of Examples and Comparative Examples at 0° C. and 60° C., the rubber compositions in which the copolymers of Examples 1 and 2 were blended had high wet traction (0° C.) and low rolling resistance (60° C.), and as a result, it can be seen that both safety and fuel efficiency of the tire to which the rubber composition is applied can be improved.

A siloxane compound according to one aspect of the present specification can improve Mooney viscosity and filler dispersibility of a conjugated diene-based polymer when used as a terminal modifying agent.

A method of preparing a siloxane compound according to another aspect of the present specification can prepare a siloxane compound in high yield.

A terminal-modified conjugated diene-based polymer according to still another aspect of the present specification and a rubber composition including the polymer have excellent mechanical properties including processability, storage stability, and wear resistance, and thus can be used as rubber materials for tire tread.

The effects of one aspect of the present specification is not limited to the above-described effects, and it should be understood to include all effects that can be inferred from the configuration described in the detailed description or claims of the present specification.

The description of the present specification described above is for illustration, and it should be understood that those of ordinary skill in the art to which one aspect of the present specification belongs can easily modify it into other specific forms without changing the technical idea or essential features described in this specification. Therefore, it should be understood that the embodiments described above are illustrative in all respects and not restrictive. For example, each component described as a single type may be implemented in a distributed form, and likewise components described as distributed may be implemented in a combined form.

The scope of the present specification is indicated by the following claims, and all changes or modifications derived from the meaning and scope of the claims and their equivalents should be construed as being included in the scope of the present specification.

What is claimed is:

1. A siloxane compound represented by Chemical Formula 1 below: 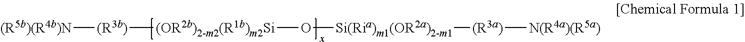
in Chemical Formula 1,
R^{1a} and R^{1b} are each independently a substituted or unsubstituted straight or branched-chain alkyl group having 1 to 16 carbon atoms,
R^{2a} and R^{2b} are each independently a substituted or unsubstituted straight or branched-chain alkyl group having 1 to 16 carbon atoms,
R^{3a} and R^{3b} are each independently a substituted or unsubstituted straight or branched-chain alkylene group having 1 to 16 carbon atoms,
R^{4a}, R^{4b}, R^{5a}, and R^{5b} are each independently hydrogen, a substituted or unsubstituted straight or branched alkyl group having 1 to 16 carbon atoms, or a substituted or unsubstituted straight or branched-chain heteroalkyl group having 1 to 16 carbon atoms,
m1 and m2 are each an integer from 0 to 2, and when m1 and m2 are each 0, a plurality of OR^{2a} and OR^{2b} are the same or different, and when m1 and m2 are each 2, a plurality of R^{1a} and R^{1b} are the same or different, and
x is an integer from 1 to 5.

2. The siloxane compound of claim 1, wherein
at least one of R^{4a}, R^{4b}, R^{5a}, and R^{5b} is an alkyl group or a heteroalkyl group substituted with a substituent represented by Chemical Formula 2 or Chemical Formula 3 below:
—Si(R^{6a})ₘ₃(OR^{6b})₃₋ₘ₃ [Chemical Formula 2]
in Chemical Formula 2,
R^{6a} is a substituted or unsubstituted straight or branched-chain alkyl group having 1 to 16 carbon atoms,
R^{6b} is a substituted or unsubstituted straight or branched-chain alkyl group having 1 to 16 carbon atoms, and
m3 is an integer from 0 to 3, and when m3 is 0 or 1, a plurality of OR^{6b} are the same or different, and when m3 is 2 or 3, a plurality of R^{6a} are the same or different,
—N(R^{7a})(R^{7b}) [Chemical Formula 3]
in Chemical Formula 3,
R^{7a} and R^{7b} are each independently a substituted or unsubstituted straight or branched-chain alkyl group having 1 to 16 carbon atoms.

3. The siloxane compound of claim 2, wherein
at least one of R^{4a} and R^{4b} is an alkyl group or a heteroalkyl group substituted with a substituent represented by Chemical Formula 2, and
at least one of R^{5a} and R^{5b} is an alkyl group or a heteroalkyl group substituted with a substituent represented by Chemical Formula 2 or Chemical Formula 3.

4. A method of preparing a siloxane compound, comprising:
(a) preparing a mixture including chloroalkylalkoxysilane represented by Chemical Formula 4 below, a primary or secondary amine, and a metal halide;
(b) reacting the mixture to obtain an aminoalkoxysilane compound; and
(c) subjecting the aminoalkoxysilane compound to a dehydration condensation reaction:
Cl—(R³)—Si(R¹)ₙ(OR²)₃₋ₙ [Chemical Formula 4]
in Chemical Formula 4,
R¹ is a substituted or unsubstituted straight or branched-chain alkyl group having 1 to 16 carbon atoms,
R² is a substituted or unsubstituted straight or branched-chain alkyl group having 1 to 16 carbon atoms,
R³ is a substituted or unsubstituted straight or branched-chain alkylene group having 1 to 16 carbon atoms, and
n is an integer of 0 to 2, and when n is 0 or 1, a plurality of OR² are the same or different, and when n is 2, a plurality of R¹ are the same or different.

5. The method of claim 4, wherein the primary or secondary amine is a compound represented by Chemical Formula 5 below:
NH(R⁴)ₒ[(R⁵)—Si(R⁶)ₚ(OR⁷)₃₋ₚ]₂₋ₒ [Chemical Formula 5]
in Chemical Formula 5,
R⁴ is hydrogen, a substituted or unsubstituted straight or branched alkyl group having 1 to 16 carbon atoms, or a substituted or unsubstituted straight or branched-chain heteroalkyl group having 1 to 16 carbon atoms,
R⁵ is a substituted or unsubstituted straight or branched-chain alkylene group having 1 to 16 carbon atoms,
R⁶ is a substituted or unsubstituted straight or branched-chain alkyl group having 1 to 16 carbon atoms,
R⁷ is a substituted or unsubstituted straight or branched-chain alkyl group having 1 to 16 carbon atoms,
o is 0 or 1, and when o is 0, a plurality of (R⁵)—Si(R⁶)ₚ(OR⁷)₃₋ₚ are the same or different, and
p is an integer from 0 to 2, and when p is 0 or 1, a plurality of OR⁷ are the same or different, and when p is 2, a plurality of R⁶ are the same or different.

6. The method of claim 4, wherein the primary or secondary amine is a compound represented by Chemical Formula 6 below:
NH(R⁸)_{q}[(R⁹)—N(R¹⁰)(R¹¹)]_{2-q} [Chemical Formula 6]
in Chemical Formula 6,
R⁸ is hydrogen, a substituted or unsubstituted straight or branched alkyl group having 1 to 16 carbon atoms, or a substituted or unsubstituted straight or branched-chain heteroalkyl group having 1 to 16 carbon atoms,
R⁹ is a substituted or unsubstituted straight or branched-chain alkylene group having 1 to 16 carbon atoms,
R¹⁰ and R¹¹ are each independently a substituted or unsubstituted straight or branched-chain alkyl group having 1 to 16 carbon atoms, and
q is 0 or 1, and when q is 0, a plurality of (R⁹)—N(R¹⁰)(R¹¹) are the same or different.

7. The method of claim 4, wherein the metal halide is a compound represented by Chemical Formula 7 below:
MX [Chemical Formula 7]
in Chemical Formula 7,
M is an alkali metal, and
X is a halogen element.

8. The method of claim 4, wherein the metal halide is a compound represented by Chemical Formula 8 below:
M′X₂ [Chemical Formula 8]
in Chemical Formula 8,
M′ is an alkaline earth metal, and
X is a halogen element.

9. The method of claim 4, wherein a content of the chloroalkylalkoxysilane included in the mixture is 1.1 to 10 moles per mole of the primary or secondary amine.

10. The method of claim 4, wherein a content of the metal halide included in the mixture is 0.01 to 5 moles per mole of the primary or secondary amine.

11. The method of claim 4, wherein the mixture further includes a base.

12. The method of claim 11, wherein the base is one selected from the group consisting of triethylamine (TEA), N,N-diisopropylethylamine (DIEA), 1,1,3,3-tetramethylguanidine (TMG), and a combination of two or more thereof.

13. The method of claim 4, wherein the reaction of step (b) is performed at 60 to 200° C.

14. The method of claim 4, wherein the reaction of step (b) is performed for 1 to 100 hours.

15. The method of claim 4, wherein the reaction of step (b) is performed under a pressure of 0.1 to 10 bar.

16. A terminal-modified conjugated diene-based polymer in which the siloxane compound according to claim 1 is bonded to an end of a conjugated diene-based polymer.

17. The terminal-modified conjugated diene-based polymer of claim 16, wherein the conjugated diene-based polymer is a homopolymer of conjugated diene-based monomers or a copolymer of a conjugated diene-based monomer and an aromatic vinyl-based monomer.

18. A rubber composition comprising the terminal-modified conjugated diene-based polymer of claim 16.
